(19) United States
(12) Patent Application Publication
(10) Pub. No.: US 2025/0299252 A1
(43) Pub. Date: Sep. 25, 2025

(54) SYSTEMS AND METHODS FOR TIERED-BASED INFORMATION PROVISION

(71) Applicant: Wells Fargo Bank, N.A., San Francisco, CA (US)

(72) Inventors: John Rhee, San Francisco, CA (US); Alexa Money, San Francisco, CA (US); Rambabu V. Gotur, San Francisco, CA (US); Orkideh Hariri, San Francisco, CA (US); James Appling, San Francisco, CA (US); Ashley L. Threatt, Rock Hill, SC (US); Matthew Mullin Shepherd, Charlotte, NC (US)

(73) Assignee: Wells Fargo Bank, N.A., San Francisco, CA (US)

(21) Appl. No.: 18/611,414

(22) Filed: Mar. 20, 2024

(51) Int. Cl. G06Q 40/04; G06F 21/60

(52) U.S. Cl. CPC G06Q 40/04; G06F 21/604; G06F 2221/2113

(57) ABSTRACT

Systems and methods are described herein for a tiered-based information provision. Such systems and methods may include authenticating a first user of a plurality of users configured to access a data exchange platform and retrieving a profile associated with the first user including an initial tier. The system receives first data supplied by the first user and stores the first data in a data structure communicatively coupled to the data exchange platform. After receiving and storing the first data, the system determines a score for the first data according to existing data in the data structure. Based on the score, the system determines an updated tier assigned to the profile associated with the first user. The system transmits second data to the first user, the second data including data received from a subset of users from the plurality of users that correspond to the updated tier.

### TECHNICAL FIELD

The present disclosure relates to incentive-driven data sharing. More specifically, the present disclosure relates to receiving information of a particular quantity, of a particular quality, or within a particular time frame according to the information that is first shared.

### BACKGROUND

Data exchange platforms allow users (e.g., investors) to receive information from other users in response to submitting information. These systems, however, receive and store significant amounts of data from a plurality of users, which in turn requires significant bandwidth for operation. Such inefficiency may, in turn, prevent users from participating the data exchange. Additionally, these systems exchange data across a universal level, meaning that users who submit less valuable information (e.g., duplicate data, outdated data, diluted data, etc.) may still be entitled to access information of a much higher value, simply by participating in the exchange.

### SUMMARY

One embodiment of the invention relates to a method. The method includes authenticating, by one or more processors, a first user of a plurality of users configured to access a data exchange platform. Responsive to authenticating the first user, the one or more processors retrieve a profile associated with the first user from the data exchange platform, the profile including an initial tier assigned to the profile associated with the first user. The method further includes receiving, via a user interface field rendered on a user device, first data supplied by the first user and storing the first data in a data structure communicatively coupled to the data exchange platform. After receiving and storing the first data, the one or more processors determine a score for the first data according to existing data included in the data structure. Based on the score determined for the first data, the one or more processors determine an updated tier assigned to the profile associated with the first user. Finally, based on the updated tier assigned to the profile associated with the first user, the one or more processors transmit second data from the data structure to the first user via the user device. The second data includes data received from a subset of users from the plurality of users that correspond to the updated tier.

In some embodiments, the method further includes transmitting, by the one or more processors, the first data from the data structure to the subset of users. In some embodiments, the one or more processors train an artificial intelligence (AI) model to generate scores for data provided as a first input to the AI model, according to a training set included as a second input to the AI model. The score assigned to the first data may be based on at least one of a quantity of the first data or a data quality metric associated with the first data. In some embodiments, an increase in the score assigned to the first data may correspond to an increase in the updated tier assigned to the profile associated with the first user. The increase in the updated tier assigned to the profile associated with the first user may correspond to receiving second data associated with at least one of a higher quantity or a higher data quality metric than a quantity or a data quality metric associated with data received at the initial tier assigned to the profile associated with the first user.

In some embodiments, the method further includes computing a duration of time from receiving the first data from the first user to transmitting the second data to the first user. The score assigned to the first data and the duration of time from receiving the first data from the first user to transmitting the second data to the first user may be inversely related, such that the duration increases as the score decreases. In some embodiments, the updated tier assigned to the profile associated with the first user may be below the initial tier assigned to the profile associated with the first user. In some embodiments, the updated tier assigned to the profile associated with the first user is one of a first tier, wherein at the first tier the first user receives a first amount of information related to a data entry, or a second tier, wherein at the second tier the first user receives a second amount of information related to the data entry, the second amount of information related to the data entry being more granular than the first amount of information related to the data entry.

Another embodiment relates to a system including a processing circuit including one or more processors and memory, the memory storing instructions that, when executed, cause the processing circuit to authenticate a first user of a plurality of users configured to access a data exchange platform. The instructions further cause the processing circuit to retrieve, responsive to authenticating the first user, a profile associated with the first user from the data exchange platform, the profile including an initial tier assigned to the profile associated with the first user. The instructions further cause the processing circuit to receive, via a user interface field rendered on a user device, first data supplied by the first user and to store the first data in a data structure communicatively coupled to the data exchange platform. The instructions further cause the processing circuit to determine a score for the first data according to existing data included in the data structure and to determine an updated tier assigned to the profile associated with the first user based on the score determined for the first data. The instructions further cause the processing circuit to transmit second data from the data structure to the first user via the user device based on the updated tier assigned to the profile associated with the first user, the second data including data received from a subset of users from the plurality of users, the subset of users corresponding to the updated tier assigned to the profile associated with the first user.

Another embodiment relates to a non-transitory computer-readable medium storing instructions that, when executed by one or more processors of a processing circuit, cause the processing circuit to authenticate a first user of a plurality of users configured to access a data exchange platform. The instructions further cause the processing circuit to retrieve, responsive to authenticating the first user, a profile associated with the first user from the data exchange platform, the profile including an initial tier assigned to the profile associated with the first user. The instructions further cause the processing circuit to receive, via a user interface field rendered on a user device, first data supplied by the first user and to store the first data in a data structure communicatively coupled to the data exchange platform. The instructions further cause the processing circuit to determine a score for the first data according to existing data included in the data structure and to determine an updated tier assigned to the profile associated with the first user based on the score determined for the first data. The instructions further cause the processing circuit to transmit second data from the data structure to the first user via the user device based on the updated tier assigned to the profile associated with the first user, the second data including data received from a subset of users from the plurality of users, the subset of users corresponding to the updated tier assigned to the profile associated with the first user.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 shows a block diagram of a computing system, according to an exemplary embodiment.

FIG. 2 shows a block diagram of an artificial intelligence (AI) system of FIG. 1, according to an exemplary embodiment.

FIG. 3 shows a block diagram of an AI model of the AI system of FIG. 2, according to an exemplary embodiment.

FIG. 4 shows an example graphical user interface (GUI) generated by the system of FIG. 1, according to an exemplary embodiment.

FIG. 5 shows another example GUI generated by the system of FIG. 1, according to an exemplary embodiment.

FIG. 6 shows a flowchart of an example method of tiered-based information provision, according to an exemplary embodiment.

FIG. 7A-7D each show a flowchart of additional steps for determining the tiered-based information provision of FIG. 6, according to an exemplary embodiment.

### DETAILED DESCRIPTION

Referring generally to the figures, systems and methods surrounding a tiered-based data exchange platform are shown. More specifically, the systems and methods facilitate exchange of data between disparate systems (e.g., between a plurality of compute device of a plurality of users). In use cases where a data exchange is used to exchange information amongst investors, investors may submit data to a data exchange that does not give other investors a significant advantage over the investor who submits the data. In other words, investors may safeguard their most valuable data to avoid providing other investors with any additional advantage. Current technology offers no solution to this dilemma, as data exchange platforms fail to address the fact that investors tend towards this behavior. Without a tiered-based data exchange, an investor who submits a highly valuable piece of information may receive, in return, less valuable data because the investors participating in the data exchange have access to all information shared across the data exchange platform. Some data exchange platforms may also require significant bandwidth to process data because there is no segmentation (e.g., tiers) within the system. Because of the bandwidth for operation of current systems, users may find significant delay between submission of information and receipt of information during the exchange. Additionally, without an incentive relating to the information that an investor might receive in return for information that they share on a data exchange platform, investors tend to keep more valuable granular data to themselves. In fact, investors can comply with current information sharing requirements and policies by merely submitting diluted data compilations that add minimal value to the information available to other investors. Therefore, data exchange platforms as they currently exist present little additional value for investors if the most valuable information is still guarded privately.

By predetermining tiers for the data that users share on a data exchange platform, users may share their more valuable information, knowing that they will receive information according to a particular standard in return. The information received in return may be of a particular quantity, quality, or may be received within a particular timeframe, depending on a tier assigned to the user profile for a given user. The information released by the user determines the tier, and the tier determines the information that the user is eligible to receive through the platform. Users, then, have an incentive to share valuable data consistently, knowing that their status will progressively improve (e.g., they will move up to a higher tier) and will grant them access to more valuable data. Additionally, by introducing tiers within the data exchange platform, the system improves bandwidth as compared to the data exchange platform that lacks a tiered exchange system. The tiers allow for targeted information to be shared with an end user according to the tier assigned to the user profile, which minimizes the amount of data that needs to be processed and evaluated as possible information to send to the user. This improved bandwidth will ensure on-demand information exchange, which may be critical for certain types of information which leverages real-time information (such as in the investment context). The tiered system also improves data quality by leveraging an artificial intelligence (AI) model that is trained to score information submitted to the data exchange. Furthermore, the AI model ensures that duplicate information is not stored to the data exchange, which reduces data storage requirements. The data exchange system incorporating a tiered mechanism for data exchange results in improved system performance and improved user satisfaction with the results of the exchange.

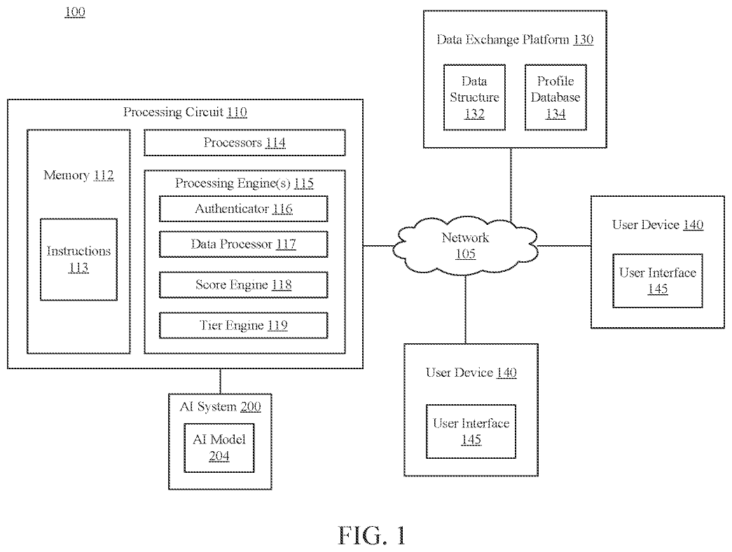

Referring to FIG. 1, a block diagram of a system 100 (e.g., an institution computing system) for implementing a tiered-based information provision according to an example embodiment is shown. In brief overview, the system 100 includes a processing circuit 110 communicably coupled to an artificial intelligence (AI) system 200, a data exchange platform 130, and at least one user device 140 (shown as two user devices, but there may be any number of user devices 140). The system 100 may be affiliated with, controlled or maintained by, or otherwise provided by a financial institution, such as a bank. As described in greater detail below, the system 100 may be configured to authenticate a first user of a plurality of users configured to access a data exchange platform (e.g., the data exchange platform 130). The system 100 may be configured to retrieve a profile associated with the first user from the data exchange platform 130, where the profile includes an initial tier assigned to the profile associated with the first user. The system 100 may be configured to receive, via a user interface field (e.g., user interface 145) rendered on a user device (e.g., the user device 140), first data supplied by the first user. The system 100 may be configured to store the first data in a data structure (e.g., data structure 132) communicatively coupled to the data exchange platform 130. The system 100 may be configured to determine a score for the first data according to existing data in the data structure 132. The system 100 may be configured to determine an updated tier assigned to the profile associated with the first user based on the score determined for the first data. The system 100 may be configured to transmit second data from the data structure 132 to the first user via the user device 140 based on the updated tier assigned to the profile associated with the first user. The second data may include data received from a subset of users corresponding to the updated tier assigned to the profile associated with the first user.

The processing circuit 110, the data exchange platform 130, and the user device 140 are in communication with each other and are connected by a network 105. The network 105 can include any type or form of one or more networks. The geographical scope of the network 105 can vary widely and the network 105 can include a local-area network (LAN), e.g., Intranet, a metropolitan area network (MAN), a wide area network (WAN), or the Internet. The topology of the network 105 can be of any form and can include, e.g., any of the following: point-to-point, bus, star, ring, mesh, or tree. The network 105 can include an overlay network which is virtual and sits on top of one or more layers of other networks. The network 105 can be of any such network topology as known to those ordinarily skilled in the art capable of supporting the operations described herein. The network 105 can utilize different techniques and layers or stacks of protocols, including, e.g., the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 105 can include a type of a broadcast network, a telecommunications network, a data communication network, or a computer network.

The processing circuit 110 may include memory 112 communicably coupled to one or more processors 114. The memory 112 stores instructions 113 configured to, for example, cause the processing circuit 110 to perform the operations corresponding to the one or more processors 114. The memory 112 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 112 may be or include tangible, non-transient volatile memory or non-volatile memory. The memory 112 may also include database components, object code components, script components, or any other type of information structure for supporting the activities and information structures described in the present application.

The one or more processors 114 may be implemented or performed with a general-purpose single- or multi-chip processor, a digital signal processor (DSP), an application specific integrated circuit (ASIC), one or more field programmable gate array (FPGAs), or other suitable electronic processing components. A general-purpose processor may be a microprocessor, or, any conventional processor, or state machine. A processor 114 also may be implemented as a combination of computing devices, such as a combination of a DSP and a microprocessor, a plurality of microprocessors, one or more microprocessors in conjunction with a DSP core, or any other such configuration. In some embodiments, the one or more processors 114 may be shared by multiple circuits (e.g., the circuits of the processor may include or otherwise share the same processor which, in some example embodiments, may execute instructions stored, or otherwise accessed, via different areas of memory). Alternatively or additionally, the one or more processors 114 may be structured to perform or otherwise execute certain operations independent of one or more co-processors. In other example embodiments, two or more processors 114 may be coupled via a bus to enable independent, parallel, pipelined, or multi-threaded instruction execution. All such variations are intended to fall within the scope of the present disclosure.

According to an exemplary embodiment, the memory 112 is communicably connected to the one or more processors 114 via the processing circuit 110 and includes computer code for executing (e.g., by the processing circuit 110 and/or the one or more processors 114) one or more processes described herein. In some embodiments, the processing circuit 110 may include one or more processing engines 115. The processing engines 115 may be or include any device, component, element, or hardware designed or configured to perform various functions of the processing circuit 110. The processing engine(s) 114 may include an authenticator 116, data processor 117, a score engine 118, and a tier engine 119. While these processing engine(s) 115 are shown and described herein, in various embodiments, additional processing engine(s) 115 may be deployed or executed at the processing circuit 110. In some embodiments, one or more processing engine(s) 115 may be combined with another processing engine 115, and/or one or more of the processing engine(s) 115 may be sub-divided into multiple processing engine(s) 115.

The processing circuit 110 may include the authenticator 116. The authenticator 116 may be or include any device, component, element, or hardware designed or configured to grant a user access to the system 100, where the user has an account associated with the financial institution. The authenticator 116 may be configured to provide various forms or types of authentication, such as single sign-on, single factor authentication, multi-factor authentication, etc. In some embodiments, the authenticator 116 may include a third-party authenticator application, an internal log-in portal, a biometric scanning device, etc. The authenticator 116 may be communicably coupled to the one or more processors 114 and the memory 112 of the processing circuit 110.

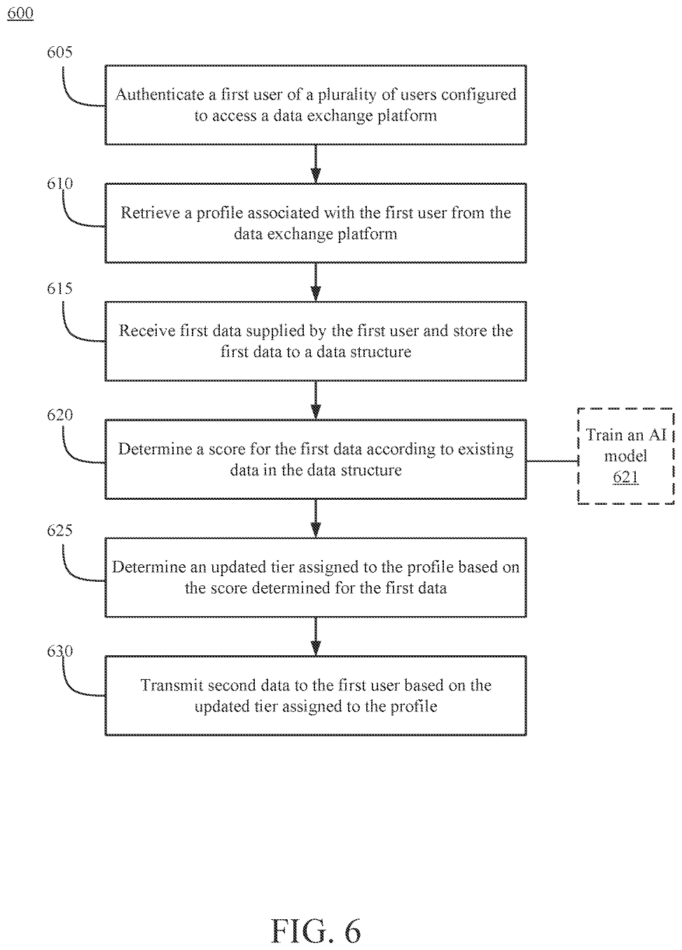

The authenticator 116 may grant a user access to the data exchange platform 130 of the system 100 by any of a plurality of authenticating methods, as described below with reference to FIG. 6. For example, a user may attempt to access the data exchange platform 130 from a user device (e.g., user device 140) via a user application associated with the system 100. The authenticator 116 may receive one or more credentials (e.g., a username, a password, a biometric scan, a pin code, etc.) and match the one or more credentials received from the user device with one or more credentials associated with a user account stored in the memory 112. Upon matching the credentials, the authenticator 116 may be configured to grant the user access to the data exchange platform 130.

The processing circuit 110 may include a data processor 117. The data processor 117 may be or include any device, component, element, or hardware designed or configured to process data received from the data exchange platform 130. In some embodiments, the data processor 117 may include one or more processors that are structured or configured to analyze, parse, inspect, or otherwise process data received from at least one of the user device 140 and the data exchange platform 130. The data processed by the data processor 117 may include information associated with an investment, trade, sale, or any other financial transaction. In some embodiments, the data processor 117 may be configured to process the data by formatting information received from the data exchange platform 130 for transmission to a user device 140, and/or format information received from a user device 140 for storage at the data exchange platform 130. The data processor 117 may be communicably coupled to the one or more processors 114 and the memory 112 of the processing circuit 110.

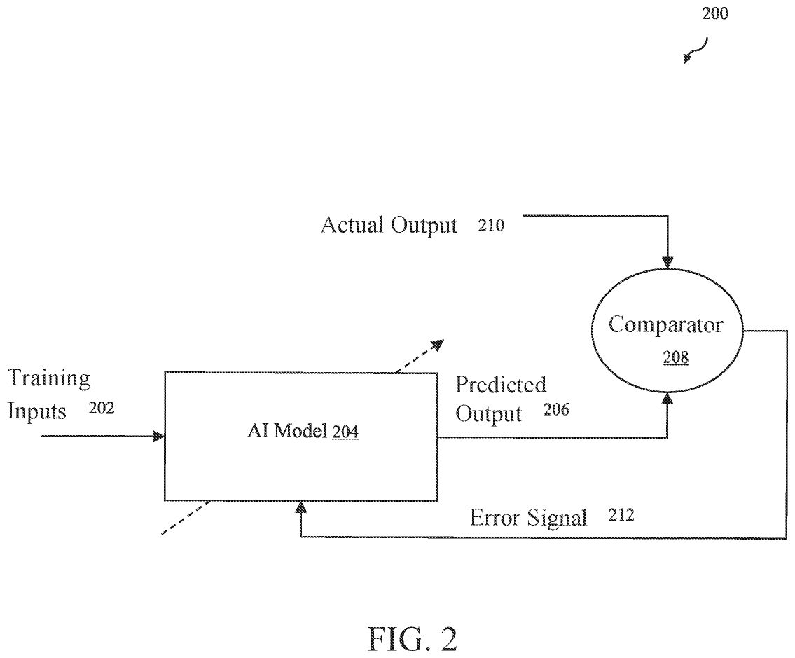

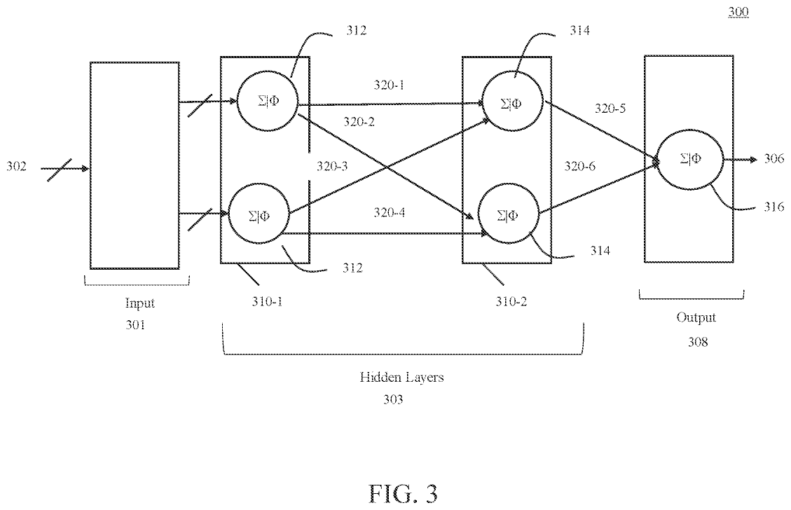

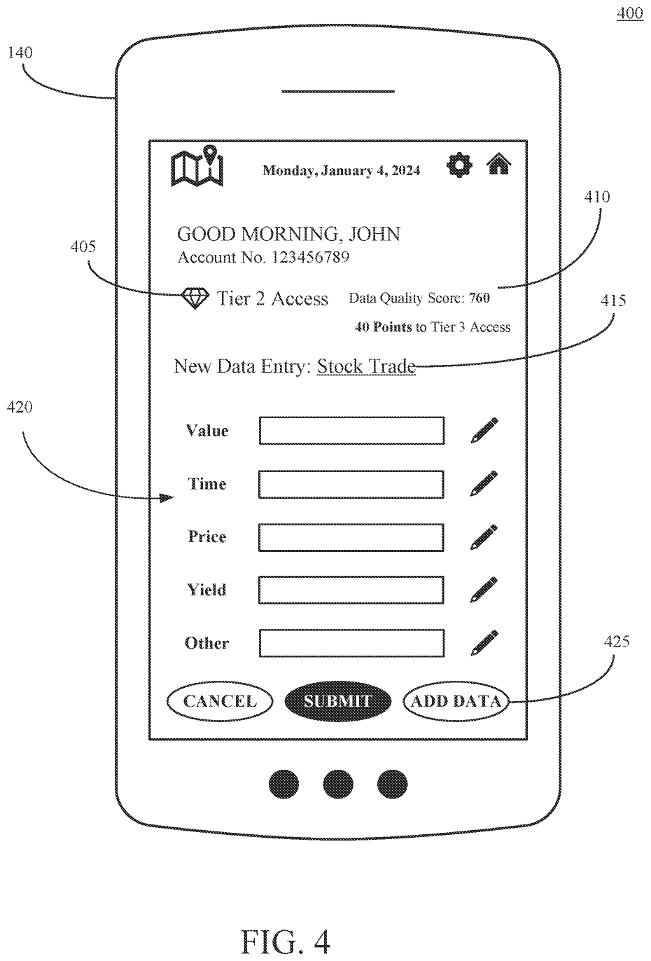

The processing circuit 110 may include a score engine 118. The score engine 118 may be or include any device, component, element, or hardware designed or configured to determine a score (e.g., a data quality score) for the data received from the user device 140 and processed by the data processor 117. The score for the data may refer to an evaluation of one or more data entries (e.g., submitted via data entry field 415, as described in greater detail below with reference to FIG. 4) submitted by a user based on one or more metrics of the data (e.g., a quantity, a data quality metric, a comparison to existing data in the data structure 132). The score may include any one of a numerical score, a percentage score, a categorical score, a textual score, and the like, out of a predefined scale. The predefined scale may be set at the data exchange level, configured or hard-coded into the processing circuit 110, the score engine 118, etc. For example. the predefined scale may be determined/set/configured by the data exchange platform 130 and transmitted to the processing circuit 110 via the network 105. Additionally or alternatively, at deployment, the score engine 118 may be preconfigured/deployed/hard-coded with the pre-defined scale. In some embodiments, the score engine 118 determines the score using an AI model (e.g., AI model 204, as described in greater detail below with reference to FIGS. 2 and 3). The score engine 118 may be communicably coupled to the one or more processors 114 and the memory 112 of the processing circuit 110.

The processing circuit 110 may include a tier engine 119. The tier engine 119 may be or include any device, component, element, or hardware designed or configured to determine/set/assign/configure a tier associated with a user account/user profile/profile of the user accessing the data exchange platform 130. The tier engine 119 may be configured to assign, determine, or otherwise select a tier to be associated with a user profile, from a plurality of tiers. Each of the plurality of tiers is configured to grant a user (e.g., corresponding to the user profile) at least one of different access to data (e.g., existing data stored in the data exchange platform 130) and/or or access to data of different levels of granularity at each successive tier. For example, a user assigned to “Tier 1” may receive data from the data exchange platform 130 at a daily frequency and/or associated with an industry-wide level of granularity. At “Tier 2,” the user may receive data from the data exchange platform 130 at the daily frequency and/or associated with an enterprise-specific level of granularity. At “Tier 3,” the user may receive data from the data exchange platform 130 at an hourly frequency and/or associated with the enterprise-specific level of granularity. “Tier 4” may allow the user to receive data at 15-minute intervals, while “Tier 5” allows on-demand access to data, for example. The tier engine 119 may receive an initial tier assigned to a profile associated with a user from the profile database 134. The tier engine 119 may then assign an updated tier associated with the user account based on various score(s) determined by the score engine 118 for data received by the data processor 117, as described above. The tier engine 119 may be communicably coupled to the one or more processors 114 and the memory 112 of the processing circuit 110.

In some embodiments, the system 100 includes the AI system 200 communicably coupled to the processing circuit 110, as described in greater detail below with reference to FIGS. 2 and 3. The AI system 200 may include AI model 204, as described below. In some embodiments, the score engine 118 determines a score for one or more data entries using the AI model 204. For example, the score engine 118 may be configured to apply the data/information received by the data processor 117 from the user device 140 to the AI model 204, and the AI model 204 may be configured to compute the score (e.g., based on the applied information as an input and information from the data exchange platform 130).

The system 100 is shown to include the data exchange platform 130. The data exchange platform 130 may be or include any device, component, element, or hardware designed or configured to facilitate exchanging information between one or more users (e.g., via the one or more user devices 140). In some embodiments, the data exchange platform 130 may include an application associated with the financial institution that can be accessed by a plurality of users authorized to access the data exchange platform 130 via the one or more user devices 140. The plurality of users may include one or more users with an account at the financial institution who have enrolled in the data exchange platform 130. The data exchange platform 130 may be communicably coupled to the processing circuit 110 and the user device 140.

The data exchange platform 130 may include a data structure 132. The data structure 132 may be or include any device, component, element, or hardware designed or configured to store the data received from the one or more user devices 140 via the data exchange platform 130. The data structure 132 may be configured to retrievably store customer information relating to various operations discussed herein, and may include non-transient data storage mediums (e.g., local disk or flash-based hard drives, local network servers, and the like) or remote data storage facilities (e.g., cloud servers). In some embodiments, the data structure 132 may include financial transaction information (e.g., information received via the data entry field 415, as described below with reference to FIG. 4) provided to the data exchange platform 130 from one or more users with access to the data exchange platform 130. The data structure 132 may be communicably coupled to the profile database 134 of the data exchange platform 130 and the processing circuit 110.

In some embodiments, the data exchange platform 130 may include a profile database 134. The profile database 134 may be or include any device, component, element, or hardware designed or configured to store information related to a profile associated with a user having an account at the financial institution. In some embodiments the profile database 134 may include non-transient data storage mediums (e.g., local disk or flash-based hard drives, local network servers, and the like) or remote data storage facilities (e.g., cloud servers). The profile database 134 may be configured to retrievably store profile information relating to the user including the tier assigned to the user profile. The user profile may be generated upon registration of a user with the data exchange platform 130 (e.g., by registering an account at the financial institution, by requesting access to the data exchange platform 130 through an existing account at the financial institution, etc.). For example, at registration, the system 100 may be configured to intake various information (e.g., personal information, financial information, other contextual information related to the user, etc.) to populate the user profile. The tier engine 119 assigns a first tier to the user profile upon registration. As the corresponding user uploads information to the data exchange platform 130 (e.g., using the data entry field 415, as described below), the tier engine 119 updates the tier assigned to the user profile based on a score associated with the uploaded information (e.g., determined by the score engine 118). In some embodiments, the tier assigned to the user profile determines the information that the user is eligible to receive from the data exchange platform 130. The tier engine 119 may transmit an updated tier to the profile database 134 upon receiving a data entry (e.g., via the data entry field 415) from a user. The profile database 134 may store the updated tier with the profile associated with the user who submitted the data entry. The profile database 134 may be communicably coupled to the data structure 132 of the data exchange platform 130 and the processing circuit 110.

In some embodiments, a user with an account at the financial institution may access the data exchange platform 130 via the user device 140. In some embodiments, the user device 140 may be a smartphone, a laptop computer, a tablet computer, a desk-top computer, and the like. The user device 140 can include a display, such as, for example, a liquid crystal display (LCD), a light-emitting diode (LED) display, an organic light-emitting diode (OLED) display, or the like. The user device 140 can receive, for example, capacitive or resistive touch input. The user device 140 may be configured to display a user interface 145. The user interface 145 may display data from the processing circuit 110 (e.g., via the data exchange platform 130) to the user. The user interface 145 can display at least one or more user or graphical user interfaces (GUIs) (e.g., interface 400, interface 500), as described in greater detail below.

Referring generally to FIG. 2 and FIG. 3, the systems and methods described herein may use, implement, or otherwise leverage various machine learning algorithms and/or artificial intelligence solutions. Examples of such solutions are described with reference to FIG. 2 and FIG. 3. While these examples are described, it is noted that additional or alternative machine learning solutions may be implemented by the systems and methods described herein.

Referring to FIG. 2, a block diagram of the AI system 200 using supervised learning, is shown. Supervised learning is a method of training a machine learning model given input-output pairs. An input-output pair is an input with an associated known output (e.g., an expected output).

The AI system 200 may include the AI model 204. The AI model 204 may be trained on known input-output pairs such that the AI model 204 can learn how to predict known outputs given known inputs. Once the AI model 204 has learned how to predict known input-output pairs, the AI model 204 can operate on unknown inputs to predict an output.

The AI model 204 may be trained based on general data (e.g., from the data structure 132) and/or granular data (e.g., data based on a specific user) such that the AI model 204 may be trained specific to a particular user.

Training inputs 202 and actual outputs 210 may be provided to the AI model 204. Training inputs 202 may include information relating to one or more data entries submitted to the data exchange platform 130 (e.g., a quantity, a data quality metric, a score associated with the data entry) and the like.

The training inputs 202 and the actual outputs 210 may be received from any of the data repositories (e.g., data structure 132, profile database 134, third-party data sources, etc.). For example, a data repository may contain information related to one or more data entries (e.g., from the data entry field 415), a corresponding score, a tier within which a user may receive the data, etc. The data repository may also include third-party information that corroborates the information received from internal data sources (e.g., the data structure 132, the profile database 134). Thus, the AI model 204 may be trained to predict a score for a data entry from a user based on the training inputs 202 and the actual outputs 210 used to train the AI model 204.

The AI system 200 may include one or more AI models 204. In an embodiment, a first AI model 204 may be trained to predict data relating to the information associated with a data entry submitted by the user to the data exchange platform 130. For example, the first AI model 204 may use the training inputs 202 to predict outputs 206 by applying the current state of the first AI model 204 to the training inputs 202. The comparator 208 may compare the predicted outputs 206 to actual outputs 210 to determine an amount of error or differences. For example, the predicted score corresponding to a data entry (e.g., predicted output 206) may be compared to the actual score associated with that data entry as determined by the score engine 118 (e.g., actual output 210).

In other embodiments, a second AI model 204 may be trained to determine the score associated with a data entry from a user based on the predicted output from the first AI model 204. In some embodiments, the first AI model 204 may be trained to determine a match score between the data submitted in a data entry and existing data in the data structure 132. Using the output from the first AI model 204 (e.g., the match score between the submitted data and the existing data), then, the second AI model 204 may be trained to generate the score associated with the data entry based on the match score predicted by the first AI model 204. For example, the second AI model 204 may use the training inputs 202 to predict outputs 206 by applying the current state of the second AI model 204 to the training inputs 202. The comparator 208 may compare the predicted outputs 206 to actual outputs 210 to determine an amount of error or differences.

In some embodiments, a single AI model 204 may be trained to determine the score associated with a data entry based on current user data received from the data exchange platform 130. That is, the single AI model 204 may be trained using the training inputs 202 to predict the outputs 206 by applying the current state of the AI model 204 to the training inputs 202. The comparator 208 may compare the predicted outputs 206 to actual outputs 210 to determine an amount of error or differences. The actual outputs 210 may be determined based on historic data associated with scoring data entries in the data exchange platform 130.

During training, the error (represented by error signal 212) determined by the comparator 208 may be used to adjust the weights in the AI model 204 such that the AI model 204 changes (or learns) over time. The AI model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the AI model 204 such that the algorithmic weights adapt based on the amount of error. The error is minimized using a loss function. Non-limiting examples of loss functions may include a square error function, a root mean square error function, and/or a cross-entropy error function.

The weighting coefficients of the AI model 204 may be tuned to reduce the amount of error, thereby minimizing the differences between (or otherwise converging) the predicted output 206 and the actual output 210. The AI model 204 may be trained until the error determined at the comparator 208 is within a certain threshold (or a threshold number of batches, epochs, or iterations have been reached). The trained AI model 204 and associated weighting coefficients may subsequently be stored in the memory 112 or other data repository such that the AI model 204 may be employed on unknown data (e.g., not training inputs 202). Once trained and validated, the AI model 204 may be employed during a testing (or an inference phase). During testing, the AI model 204 may ingest unknown data to predict future data (e.g., scores corresponding to future data entries with one or more common parameters as past data entries).

Referring to FIG. 3, a block diagram of a simplified neural network model 300 is shown. The neural network model 300 may include a stack of distinct layers (vertically oriented) that transform a variable number of inputs 302 being ingested by an input layer 301, into an output 306 at the output layer 308.

The neural network model 300 may include a number of hidden layers 310 between the input layer 301 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

Referring now to FIG. 4, an interface 400 on a user device is shown according to an example embodiment. In some embodiments, the interface 400 is generated by the system 100 for display/rendering on the user device 140. In brief, the interface 400 includes graphics or user interface elements displaying information relating to a new data entry from a user to the data exchange platform 130. The graphics displayed on the interface 400 may be customizable by the user or by the institution computing system (e.g., the system 100). In the embodiment shown, the interface 400 includes a current tier 405, one or more tier metrics 410, a data entry field 415, one or more parameter fields 420, and a selectable element 425.

Still referring to FIG. 4 and in further detail, the interface 400 includes the current tier 405. In some embodiments, the current tier 405 is a tier determined by the tier engine 119, as described above. The current tier 405 determines/sets/establishes information (or types of information) that a user is eligible to receive depending on the current tier 405. For example, if the interface 400 displays the current tier 405 as “Tier 2 Access,” the user is eligible to receive information stored in the data structure 132 corresponding to an access level of tier 2. The current tier 405 is particular to a profile (e.g., the profile stored in the profile database 134) associated with a user account with which the user accesses the user device 140. In some embodiments, the current tier 405 is a real-time indication of a tier associated with the user account. The current tier 405 may update to reflect changes in the tier associated with the user account. For example, the current tier 405 may update upon receiving additional information via the data exchange platform 130 from the user account associated with the user).

The interface 400 includes one or more tier metrics 410. The one or more tier metrics 410 refers to one or more metrics associated with the current tier 405 associated with the user account. In some embodiments, the one or more tier metrics 410 are retrieved from the profile database 134. For example, the one or more tier metrics 410 may include a data quality score. The data quality score may be associated with the user profile from which a user accesses the data exchange platform 130 and may be stored in the profile database 134. In some embodiments, the data quality score refers to an overall score (e.g., an overall score determined by the score engine 118) related to a user history of data entries (e.g., a history of data entries submitted via the data entry field 415 associated with the user account). The overall score may be presented as any one of a numerical score, a percentage score, a categorical score, a textual score, and the like, out of a predefined scale.

In some embodiments, the one or more tier metrics 410 includes a distance to a successive tier from the current tier 405. The distance to the successive tier may refer to an increase in the data quality score to reach the successive tier. In some embodiments, the distance is determined by the one or more processors 114 (e.g., the data processor 117, the score engine 118, the tier engine 119). The distance may be measured using a number, a percentage, a category, or any other metric corresponding to a unit used to measure the quality score. In some embodiments, the distance may be a selectable element. Upon receiving an indication that the user has interacted with the selectable element, the interface 400 may suggest one or more data entries allowing the user to reach the successive tier. For example, the suggested one or more data entries may be related to a particular topic, a particular quantity, a particular quality, etc., that increase the data quality score by the amount indicated by the distance to the successive tier from the current tier. For example, if a user account has “Tier 2 Access” and has a data quality score of 760 points, the one or more tier metrics 410 may also indicate that the user is 40 points away from gaining “Tier 3 Access.” In this example, the user may interact with the selectable element displaying the distance to the successive tier (e.g., “40 Points”). The interface 400 may indicate that the user may be able to reach “Tier 3 Access” upon submitting a data entry (e.g., via the data entry field 415) including information relating to a well-performing financial security, a particular amount of granular data relating to one or more trades, information relating to a new trade, etc.

The interface 400 includes a data entry field 415. The data entry field 415 may indicate the type of information that the user is submitting via the interface 400. In some embodiments, a title of the data entry may be selected by a user from a drop-down list of possible categories of data entries. For example, the drop-down list may include stocks, cryptocurrency, bonds, contracts, currency, or any other asset, commodity, security, or the like that may be involved in a transaction. In some embodiments, the drop-down list may also include the type of transaction related to the data entry field 415. The type of transaction may also be included in the drop-down list of possible categories or may be included in a second drop-down list. For example, the type of transaction may include a trade, a purchase, a sale, a payment, a receipt, or any other action relating to the list of possible categories involved in the transaction.

The interface 400 includes one or more parameter fields 420. The one or more parameter fields 420 may be related to the data entry submitted via the data entry field 415 and may be populated with granular data related to the data entry. For example, the one or more parameter fields 420 may include a value, a time, a price, a yield, or other information related to a transaction associated with the data entry. In some embodiments, the one or more parameter fields 420 include a free-text box where a user can enter relevant information for each of the one or more parameter fields 420. The one or more parameter fields 420 may also include a selectable element (e.g., a pencil icon) configured to allow the user to edit the information included in the free-text box. The amount of data that a user submits relating to the one or more parameter fields 420 may contribute to a data quality metric determined by the one or more processors 114 for the data entry. For example, if a user submits information relating to the value, the time, and the price associated with a transaction, that data entry may receive a lower data quality metric than a data entry related to the same transaction that includes the value, the time, the price, and the yield associated with the same transaction.

The interface 400 includes a selectable element 425. The selectable element 425 refers to an action that a user can perform via the interface 400 upon submitting information for the one or more parameter fields 420. In some embodiments, the interface 400 may include a plurality of selectable elements 425. The plurality of selectable elements 425 may allow a user to, for example, cancel the data entry, submit the data entry to the data exchange platform 130, or add a new data entry. A selectable element 425 with which the user can add a new data entry allows the user to submit a plurality of data entries to the data exchange platform 130 at the same time. For example, if the user submits five data entries (e.g., via five data entry fields 415) to the data exchange platform 130, the tier associated with the user account may update responsive to receiving the five data entries. Being able to submit a plurality of data entries with one submission may be beneficial for data entries that are time-sensitive (e.g., where the value associated with the information in the data entry decreases with time). Additionally, submission of a plurality of data entries with one submission may lessen bandwidth by transmitting the plurality of data entries together rather than as separate transmissions for each of the data entries. User efficiency may also increase with the ability to submit the plurality of data entries with one submission by reducing a total number of clicks required for populating additional data entries (e.g., in the data entry field 415).

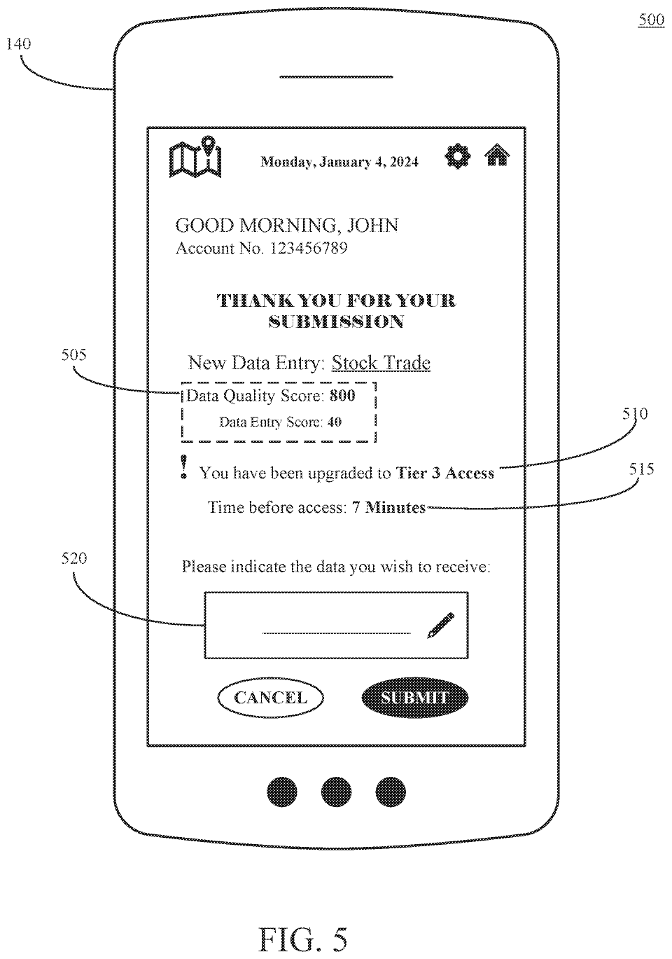

Referring now to FIG. 5, an interface 500 on a user device is shown according to an example embodiment. In some embodiments, the interface 500 is generated by the system 100 on the user device 140. In brief, the interface 500 includes information presented to a user upon receipt of a data entry submitted via the data entry field 415 (e.g., by a user via interface 400) by the data exchange platform 130. The graphics displayed on the interface 500 may be customizable by the user or by the institution computing system (e.g., the system 100). In the embodiment shown, the interface 500 displays a data quality score 505, an updated tier 510, a duration of time 515, and a free-text box 520.

Still referring to FIG. 5 and in further detail, the interface 500 includes the data quality score 505. The data quality score 505 refers to an updated score associated with the user profile based on the data entry submitted via the interface 400. The data quality score 505 may include a data entry score. The data entry score refers to an individual score associated with the data entry (e.g., 40). In some embodiments, the data quality score 505 is determined by the score engine 118, as described above with reference to FIG. 1. The data quality score 505 may be presented as a numerical score, a percentage score, a categorical score, a textual score, and the like, out of a predefined scale.

The interface 500 includes an updated tier 510. The updated tier 510 refers to a level of access granted to the user upon receipt of the data entry by the data exchange platform 130. The updated tier 510 may be determined by the tier engine 119, as described above with reference to FIG. 1. As described above, the updated tier 510 may be one of a plurality of tiers included in the data exchange platform 130. Each of the plurality of tiers may be associated with a particular data quality score threshold. The data quality score threshold associated with each of the plurality of tiers may be determined/set/configured by the data exchange platform 130 and transmitted to the processing circuit 110 (e.g., the tier engine 119) via the network 105. Each of the plurality of tiers is configured to grant a user at least one of different access to data (e.g., existing data stored in the data exchange platform 130) and/or or access to data of different levels of granularity at each successive tier. For example, a user assigned to “Tier 1” may receive data from the data exchange platform 130 at a daily frequency and/or associated with an industry-wide level of granularity. At “Tier 2,” the user may receive data from the data exchange platform 130 at the daily frequency and/or associated with an enterprise-specific level of granularity. At “Tier 3,” the user may receive data from the data exchange platform 130 at an hourly frequency and/or associated with the enterprise-specific level of granularity. “Tier 4” may allow the user to receive data at 15-minute intervals, while “Tier 5” allows on-demand access to data, for example.

In some embodiments, the updated tier 510 includes at least one of a same level of access as the current tier 405, a higher level of access than the current tier 405, or a lower level of access as the current tier 405. For example, if the data entry does not cause the data quality score associated with the user account (e.g., as presented by the one or more tier metrics 410) to increase or decrease by a sufficient amount, the updated tier 510 may be the same as the current tier 405 and the user may have the same level of access. The sufficient amount refers to a distance from the current tier 405 to the successive tier or to a distance from a preceding tier to the current tier 405. If the data entry does cause the data quality score associated with the user account to increase by the sufficient amount in order to reach the successive tier (e.g., by 40 points as shown in FIG. 4), the updated tier 510 may be higher than the current tier 405 and the user may have a higher level of access. Alternatively, if the data entry causes the data quality score associated with the user account to decrease by the sufficient amount in order to reach the preceding tier, the updated tier 510 may be lower than the current tier 405 and the user may have a lower level of access. The updated tier 510 may be stored in the profile database 134.

The interface 500 includes the duration of time 515. In some embodiments, the duration of time 515 refers to a duration of time before which the user may receive information in response to the data entry. The duration of time 515 may correspond to the updated tier 510. For example, the duration of time 515 associated with “Tier 2 Access” may include a 15-minute duration, while the duration of time 515 associated with “Tier 3 Access” may include a seven-minute duration. In some embodiments, the duration of time 515 corresponding to each of the tiers is stored in at least one of the memory 112 or the data exchange platform 130. The duration of time 515 corresponding to each of the tiers may further include a range of time. For example, the duration of time 515 corresponding to the “Tier 2 Access” may include a range of 12-20 minutes, while the duration of time corresponding to the “Tier 3 Access” may include a range of 6-12 minutes.

Where the duration of time 515 corresponding to each of the tiers includes a range of time, the duration of time 515 displayed on the interface 500 may be determined by the tier engine 119 depending on the data quality score 505 associated with the data entry submitted via the data entry field 415. In some embodiments, the tier engine 119 may determine a duration of time 515 within the range of time in proportion to where the data quality score 505 falls relative to a mean data quality score for data entries in the same category as the data entry. For example, if the data quality score associated with a data entry is within the 75^{th} percentile of data quality scores associated with data entries from the same category as the data entry, the duration of time 515 may be within the 75^{th} percentile of the range of time (e.g., for an updated tier 510 corresponding to a range of 12-20 minutes, the tier engine 119 may determine the duration of time 515 as 14 minutes).

The interface 500 includes the free-text box 520. The free-text box 520 refers to an area on the interface 500 where a user may request second data that the user prefers to receive from the data exchange platform 130 in response to submitting a data entry via the data entry field 415. In some embodiments, the user may submit one or more key-words in the free-text box 520 that the data exchange platform 130 may use to determine the information that is sent to the user after the duration of time 515. For example, the one or more key words may include a type of security involved in a transaction, a type of transaction, a value of a transaction, a time of a transaction, a price of a transaction, etc. In some embodiments, the user may include one or more Boolean operators (e.g., “and,” “or,” “not,” etc.) between the one or more key words to further filter the information that the user prefers to receive.

Upon indicating the information that the user prefers to receive using the free-text box 520, the interface 500 may include one or more selectable elements configured to submit the request for the information or to cancel the request. Once the user submits the request via the interface 500, the data processor 117 may retrieve information from the data structure 132 associated with the one or more key words indicated by the user in the free-text box 520 and corresponding to the updated tier 510. After the duration of time 515 passes, the processing circuit 110 transmits the information retrieved by the data processor 117 from the data structure 132 to the user via the user device 140.

Referring now to FIG. 6, a flow diagram of a method 600 for submitting and receiving information via a data exchange platform is shown according to an example embodiment. In some embodiments, the method 600 is performed by the system 100. As a brief overview, at step 605, the authenticator 116 authenticates a first user of a plurality of users configured to access the data exchange platform 130. At step 610, the processing circuit 110 retrieves a profile associated with the first user from the data exchange platform 130 (e.g., from the profile database 134). At step 615, the data processor 117 receives first data supplied by the first user and stores the first data to the data structure 132. At step 620, the score engine 118 determines a score for the first data according to existing data in the data structure 132. In some embodiments, the AI model 204 is trained at step 621 and the AI model 204 is used to determine the score for the first data. At step 625, the tier engine 119 determines an updated tier assigned to the profile associated with the first user based on the score determined for the first data at step 620. At step 630, the processing circuit 110 transmits second data to the first user based on the updated tier assigned to the profile at step 625.

Continuing with FIG. 6 and in more detail, the method 600 begins when the authenticator 116 authenticates the first user of the plurality of users configured to access the data exchange platform 130 at step 605. In some embodiments, the authenticator 116 is prompted to authenticate the first user upon receiving an indication that the first user is attempting to access the data exchange platform 130 via the user device 140. For example, the indication may include a notification that the first user is attempting to log into an application for accessing the data exchange platform 130 via the user device 140. In some embodiments, the authenticator 116 may authenticate the user by any of a plurality of authenticating methods. For example, the plurality of authenticating methods may include requesting credentials (e.g., an account number, a password, a pin code, etc.) or biometric information (e.g., a fingerprint, a hand scan, a vocal sample, a retina scan, etc.).

Upon authenticating the first user at step 605, the processing circuit 110 retrieves the profile associated with the first user from the data exchange platform 130. The profile associated with the first user may be stored in the profile database 134. In some embodiments, the profile associated with the first user includes a current tier (e.g., the current tier 405, as described above with reference to FIG. 4) that defines an access level to information that the first user is entitled. The profile associated with the first user may include a data quality score (e.g., the data quality score included in the one or more tier metrics 410, as described above with reference to FIG. 4) corresponding to the profile. In some embodiments, the profile database 134 identifies a history of data entries stored in the data structure 132 that correspond to one or more data entries submitted by the user (e.g., via the data entry field 415).

The data processor 117 receives first data supplied by the first user at step 615. In some embodiments, the first user supplies the first data using the data entry field 415 via the interface 400, as described above with reference to FIG. 4. The data processor 117 may be further configured to store the first data in the data structure 132 of the data exchange platform 130. In some embodiments, storing the data in the data structure 132 includes associating the first data with a tier. Once the first data is stored in the data structure 132 according to a particular tier, the first data may be available to a plurality of users configured to access the information eligible at that particular tier.

After the data processor 117 receives and stores the first data, the score engine 118 determines the score for the first data at step 620. The score for the first data may be determined according to existing data in the data structure 132. For example, the score engine 118 may receive, from the data processor 117, an indication of whether the first data is a duplicate of information that is already stored in the data structure 132. The data processor 117 may identify whether the first data contains duplicate information by comparing one or more key words associated with the data entry containing the first data and one or more key words associated with data entries that have previously been stored in the data structure 132. For example, if the data processor 117 identifies at least one data entry in the data structure 132 that includes all of the key words associated with the data entry containing the first data, the data processor 117 may determine that the first data is duplicate data. The data processor 117 may be configured to communicate the indication of duplicate data to the score engine 118.

Determining the score for the first data at step 620 may further include training an AI model at step 621. In some embodiments, the AI model is the AI model 204, as described above with reference to FIG. 2 and FIG. 3.

At step 625, the tier engine 119 determines an updated tier assigned to the profile of the first user based on the score determined at step 620. The tier engine 119 may receive the score for the first data from the score engine 118. After receiving the score for the first data, the tier engine 119 may be configured to determine whether the score for the first data accounts for the delta/difference/distance to reach the successive tier (e.g., the distance as described above with reference to FIG. 4). If the score received from the score engine 118 accounts for the distance, the tier engine 119 may assign the successive tier to the profile associated with the user account from which the user is accessing the data exchange platform 130. In some embodiments, the tier engine 119 transmits the updated tier to the profile database 134. Then, the profile database 134 may assign the updated tier to the profile stored in the profile database 134. In some embodiments, the tier engine 119 may determine an updated tier that is below a current tier assigned to the user profile. For example, if a user is inactive on the data exchange platform 130 (e.g., does not submit a data entry via the data entry field 415) for a period of time, the tier engine 119 may be configured to assign an updated tier to the user profile that is below the current tier assigned to the user profile. Reducing the tier assigned to the user profile may incentivize activity on the data exchange platform 130 and encourage users to submit new data. As another example, if the data processor 117 determines that the user submits duplicate data (e.g., existing data in the data structure 132), the tier engine 119 may be configured to assign an updated tier to the user profile that is below the current tier. In this example, the score engine 118 may determine a negative score associated with the duplicate data. Therefore, after receiving the negative score from the score engine 118, the tier engine 119 may be configured to determine whether the negative score for the duplicate data accounts for the delta/difference/distance to reach a previous tier.

The processing circuit 110 transmits second data to the first user at step 630 based on the updated tier determined at step 625. In some embodiments, the data processor 117 identifies the second data to transmit to the first user. The second data may be determined according to the one or more key words indicated by the first user using the free-text box 520 via the interface 500. The data processor 117 may receive the updated tier assigned to the profile of the first user from the tier engine 119. Based on the updated tier, the data processor 117 retrieves data from the data structure 132 associated with the updated tier and including at least one of the one or more key words indicated in the free-text box 520. In some embodiments, the data processor 117 determines that no data in the data structure 132 corresponds to both the updated tier and to at least one of the one or more key words indicated in the free-text box 520. In this instance, the data processor 117 may determine the second data by analyzing one or more previous sets of second data the user has received from the data exchange platform 130 and filter the data associated with the updated tier in the data structure 132 according to data that the first user has not previously received nor submitted.

In some embodiments, the second data may be transmitted to the first user following the duration of time 515 indicated on the interface 500, as described above with reference to FIG. 5. The second data may be transmitted to the first user via the user device 140. In some embodiments, the second data may include an expiration. The expiration refers to a time frame after which the first user is no longer permitted to view the second data. The expiration may be a predetermined amount of time associated with the updated tier. For example, “Tier 2 Access” may have a predefined expiration after two hours, “Tier 3 Access” may have a predefined expiration after three hours, etc. Alternatively or additionally, the expiration may be determined by the data quality score associated with the data entry submitted via the data entry field 415. For example, the first user may receive an expiration for the second data in proportion to the data quality score assigned to the data entry including the first data. In some embodiments, the first user may be permitted to view the second data indefinitely.

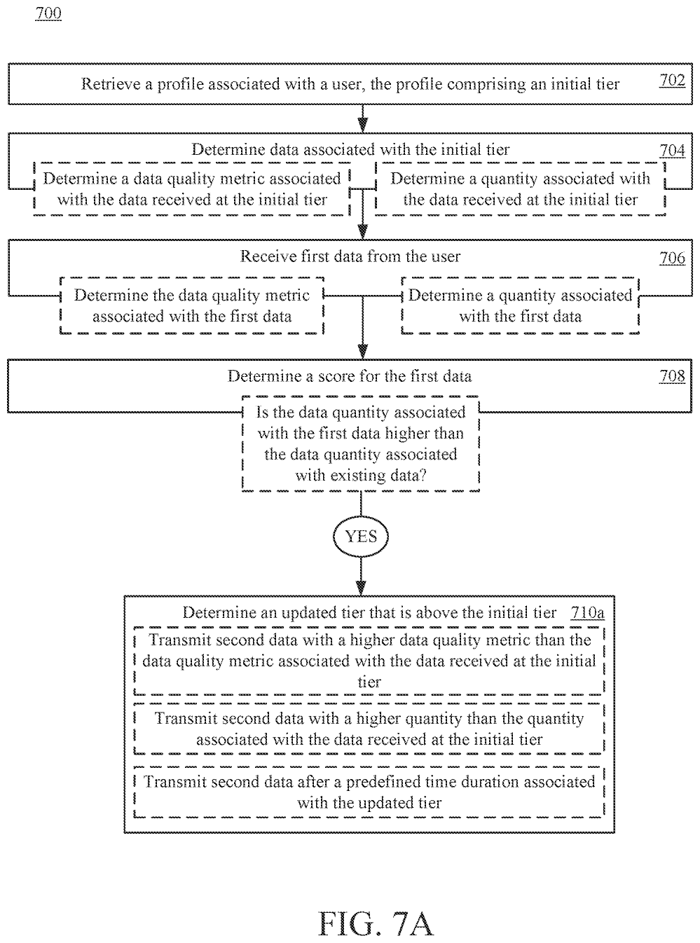

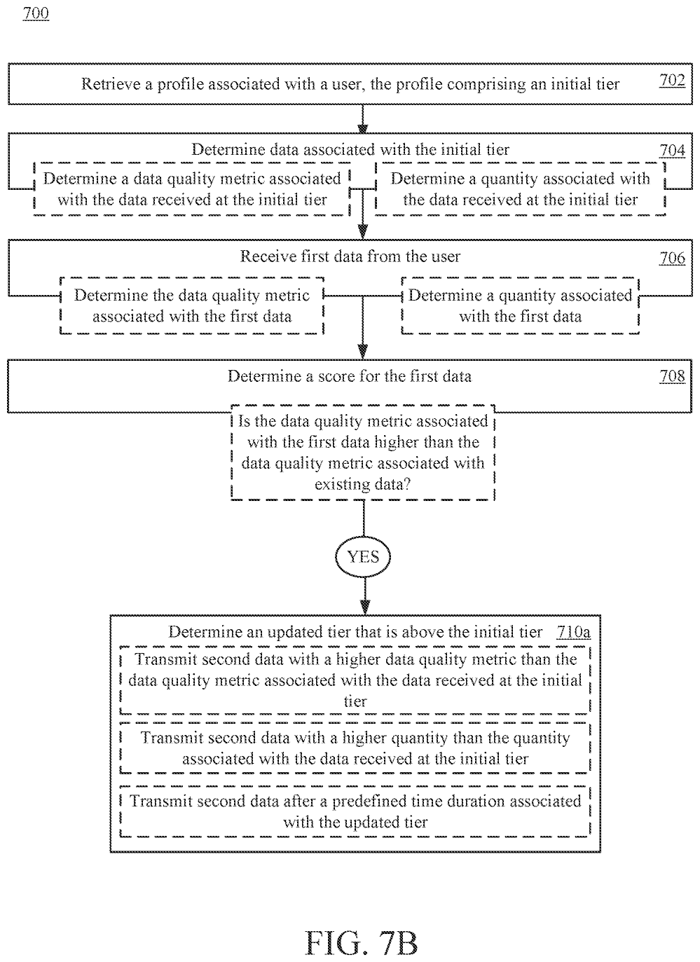

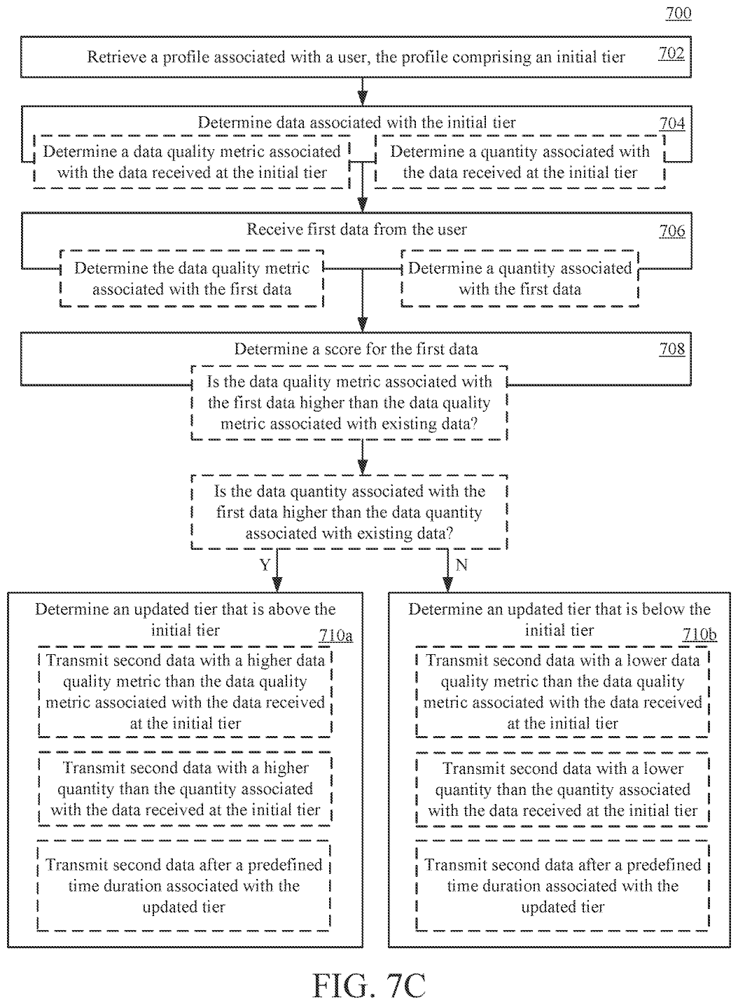

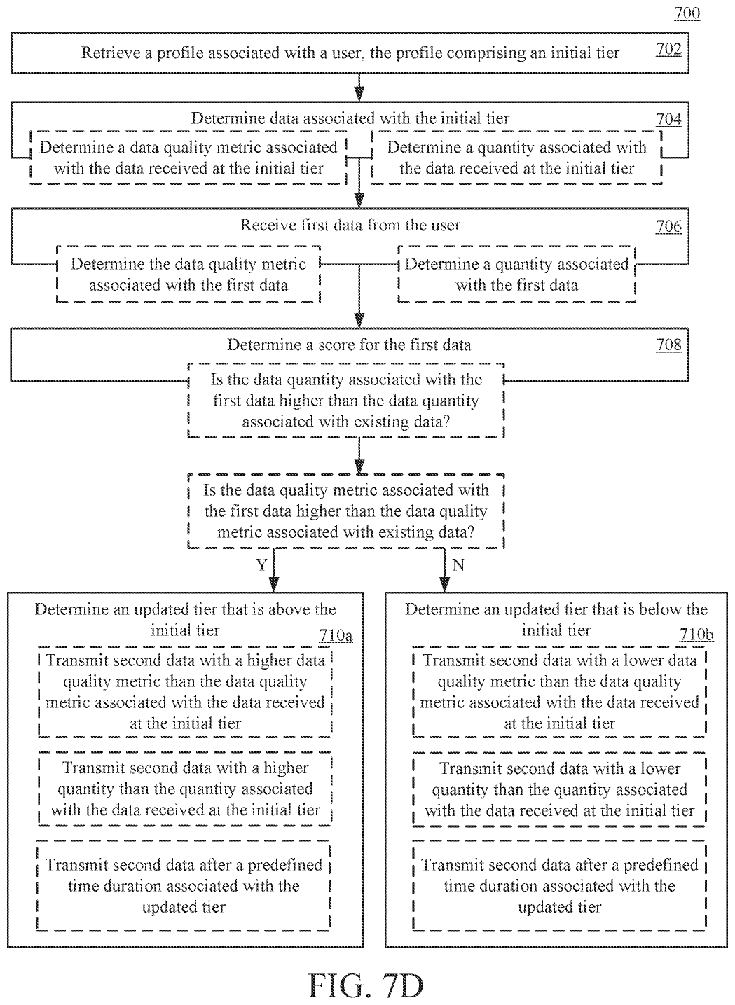

Referring to now to FIG. 7A-7D, a flow diagram of a method 700 including additional steps for determining an updated tier assigned to a user profile is shown. In some embodiments, method 700 is performed by the system 100. As a brief overview, the method 700 includes the processing circuit 110 retrieving a profile associated with a user and including an initial tier at step 702. The data processor 117 determines data (e.g., stored in the data structure 132) associated with the initial tier at step 704. The data processor 117 receives first data from the user at step 706. After the data processor 117 receives the first data at step 706, the score engine 118 determines a score for the first data at step 708. Based on the score determined by the score engine 118 at step 708, the tier engine 119 determines an updated tier that is above the initial tier at 710a or the tier engine 119 determines an updated tier that us below the initial tier at step 710b.

Continuing with FIG. 7A-7D and in more detail, the method 700 begins when the processing circuit 110 retrieves a profile associated with a user at step 702, the profile including an initial tier. In some embodiments, the processing circuit 110 retrieves the profile from the profile database 134. Step 702 of method 700 may be similar or identical to step 610 of method 600. Although not illustrated in FIG. 7A-7D, method 700 may begin when the authenticator 116 authenticates a user attempting to access the data exchange platform 130, as described above with reference to step 605 of method 600 in FIG. 6.

Based on the initial tier identified at step 702, the data processor 117 determines data associated with the initial tier at step 704. As described above, the data stored in the data structure 132 may be associated with a particular tier. In some embodiments, the data processor 117 may be configured to identify data stored in the data structure 132 that is associated with the initial tier indicated by the profile of the user. The data associated with the initial tier refers to data received by a user eligible to access information according to the access level as defined by the initial tier. In some embodiments, the data processor 117 may be further configured to determine a data quality metric associated with the data received at the initial tier. The data processor 117 may be further configured to determine a quantity associated with the data received at the initial tier.

The data processor 117 receives first data from the user at step 706. In some embodiments, step 706 of method 700 may be similar or identical to step 615 of method 600. Upon receiving the first data, the data processor 117 may be configured to determine the data quality metric associated with the first data. The data processor 117 may be further configured to determine a quantity associated with the first data. For example, the data processor 117 may identify that the first data includes one or more data entries submitted via the data entry field 415, as described above with reference to FIG. 4.

The score engine 118 determines a score for the first data at step 708. In some embodiments, step 708 may be similar or identical to step 620 of method 600. The score engine 118 may be configured to determine if the data quality metric associated with the first data is higher than the data quality metric associated with existing data in the data structure 132 (e.g., existing data from one or more previous data entries). The score engine 118 may be further configured to determine if the data quantity associated with the first data is higher than the data quantity associated with existing data in the data structure 132.

Referring specifically to FIG. 7A, if the score engine 118 determines that the quantity associated with the first data is higher than the quantity associated with the existing data, then the tier engine 119 may be configured to determine an updated tier that is above the initial tier at step 710a. In some embodiments, upon determining that the updated tier is above the initial tier, the data processor 117 may be configured to identify, from the data structure 132, second data corresponding to a higher data quality metric than the data quality metric associated with the data received at the initial tier. Alternatively or additionally, the data processor 117 may be configured to identify, from the data structure 132, second data corresponding to a higher quantity than the quantity associated with the data received at the initial tier. After the data processor 117 identifies the second data, the processing circuit 110 may be configured to transmit the second data to the user (e.g., to the user device 140) via the data exchange platform 130. In some embodiments, the second data may be transmitted after a predetermined time duration associated with the updated tier (e.g., the duration of time 515).

Referring specifically to FIG. 7B, if the score engine 118 determines that the data quality metric associated with the first data is higher than the data quality metric associated with the existing data, then the tier engine 119 may be configured to determine an updated tier that is above the initial tier at step 710a, as described above with reference to FIG. 7A.

Referring specifically to FIG. 7C, if the score engine 118 determines that the data quality metric associated with the first data is not higher than the data quality metric associated with the existing data, but that the quantity associated with the first data is higher than the quantity associated with the existing data, the tier engine 119 may be further configured to determine an updated tier that is above the initial tier at step 710a, as described above with reference to FIG. 7A.

Alternatively, if the score engine 118 determines that neither the data quality metric associated with the first data nor the quantity associated with the first data are higher than the data quality metric associated with the existing data and the quantity associated with the existing data, respectively, the tier engine 119 may be further configured to determine an updated tier that is below the initial tier at step 710b. In some embodiments, upon determining that the updated tier is below the initial tier, the data processor 117 may be configured to identify, from the data structure 132, second data corresponding to a lower data quality metric than the data quality metric associated with the data received at the initial tier. Alternatively or additionally, the data processor 117 may be configured to identify, from the data structure 132, second data corresponding to a lower quantity than the quantity associated with the data received at the initial tier. After the data processor 117 identifies the second data, the processing circuit 110 may be configured to transmit the second data to the user (e.g., to the user device 140) via the data exchange platform 130. In some embodiments, the second data may be transmitted after a predetermined time duration associated with the updated tier (e.g., the duration of time 515).

Referring specifically to FIG. 7D, if the score engine 118 determines that the quantity associated with the first data is not higher than the quantity associated with the existing data, but that the data quality metric associated with the first data is higher than the data quality metric associated with the existing data, the tier engine 119 may be further configured to determine an updated tier that is above the initial tier at step 710a, as described above with reference to FIG. 7A.

Alternatively, if the score engine 118 determines that neither the quantity associated with the first data nor the data quality metric associated with the first data are higher than the quantity associated with the existing data and the data quality metric associated with the existing data, respectively, the tier engine 119 may be further configured to determine an updated tier that is below the initial tier at step 710b, as described above with reference to FIG. 7C.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web embodiments of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
authenticating, by one or more processors, a first user of a plurality of users configured to access a data exchange platform;
retrieving, by the one or more processors, responsive to authenticating the first user, a profile associated with the first user from the data exchange platform, the profile comprising an initial tier assigned to the profile associated with the first user;
receiving, by the one or more processors, via a user interface field rendered on a user device, first data supplied by the first user;
storing, by the one or more processors, the first data in a data structure communicatively coupled to the data exchange platform;
determining, by the one or more processors, a score for the first data, the score determined for the first data according to existing data included in the data structure;
determining, by the one or more processors, an updated tier assigned to the profile associated with the first user, based on the score determined for the first data; and
transmitting, by the one or more processors, second data from the data structure to the first user via the user device based on the updated tier assigned to the profile associated with the first user, the second data comprising data received from a subset of users from the plurality of users, the subset of users corresponding to the updated tier assigned to the profile associated with the first user.

2. The method of claim 1, further comprising transmitting, by the one or more processors, the first data from the data structure to the subset of users.

3. The method of claim 1, further comprising training, by the one or more processors, an artificial intelligence (AI) model to generate scores for data provided as a first input to the AI model, according to a training set included as a second input to the AI model.

4. The method of claim 1, wherein the score assigned to the first data is based on at least one of a quantity of the first data or a data quality metric associated with the first data.

5. The method of claim 1, wherein an increase in the score assigned to the first data corresponds to an increase in the updated tier assigned to the profile associated with the first user.

6. The method of claim 5, wherein the increase in the updated tier assigned to the profile associated with the first user corresponds to receiving second data associated with at least one of a higher quantity or a higher data quality metric than a quantity or a data quality metric associated with data received at the initial tier assigned to the profile associated with the first user.

7. The method of claim 1, further comprising computing, by the one or more processors, a duration of time from receiving the first data from the first user to transmitting the second data to the first user.

8. The method of claim 7, wherein the score assigned to the first data and the duration of time from receiving the first data from the first user to transmitting the second data to the first user are inversely related, such that the duration increases as the score decreases.

9. The method of claim 1, wherein the updated tier assigned to the profile associated with the first user is below the initial tier assigned to the profile associated with the first user.

10. The method of claim 1, wherein the updated tier assigned to the profile associated with the first user is one of:
a first tier, wherein at the first tier the first user receives a first amount of information related to a data entry; or
a second tier, wherein at the second tier the first user receives a second amount of information related to the data entry, the second amount of information related to the data entry being more granular than the first amount of information related to the data entry.

11. A system comprising:
a processing circuit comprising one or more processors and memory, the memory storing instructions that, when executed, cause the processing circuit to:
authenticate a first user of a plurality of users configured to access a data exchange platform;
retrieve, responsive to authenticating the first user, a profile associated with the first user from the data exchange platform, the profile comprising an initial tier assigned to the profile associated with the first user;
receive, via a user interface field rendered on a user device, first data supplied by the first user;
store the first data in a data structure communicatively coupled to the data exchange platform;
determine a score for the first data, the score determined for the first data according to existing data included in the data structure;
determine an updated tier assigned to the profile associated with the first user, based on the score determined for the first data; and
transmit second data from the data structure to the first user via the user device based on the updated tier assigned to the profile associated with the first user, the second data comprising data received from a subset of users from the plurality of users, the subset of users corresponding to the updated tier assigned to the profile associated with the first user.

12. The system of claim 11, the instructions further causing the processing circuit to transmit the first data from the data structure to the subset of users.

13. The system of claim 11, the instructions further causing the processing circuit to train an artificial intelligence (AI) model to generate scores for data provided as a first input to the AI model, according to a training set included as a second input to the AI model.

14. The system of claim 11, wherein the score assigned to the first data is based on at least one of a quantity of the first data or a data quality metric associated with the first data.

15. The system of claim 11, wherein an increase in the score assigned to the first data corresponds to an increase in the updated tier assigned to the profile associated with the first user.

16. The system of claim 15, wherein the increase in the updated tier assigned to the profile associated with the first user corresponds to receiving second data associated with at least one of a higher quantity or a higher data quality metric than a quantity or a data quality metric associated with data received at the initial tier assigned to the profile associated with the first user.

17. The system of claim 11, the instructions further causing the processing circuit to compute a duration of time from receiving the first data from the first user to transmitting the second data to the first user.

18. The system of claim 17, wherein the score assigned to the first data and the duration of time from receiving the first data from the first user to transmitting the second data to the first user are inversely related, such that the duration increases as the score decreases.

19. The system of claim 11, wherein the updated tier assigned to the profile associated with the first user is below the initial tier assigned to the profile associated with the first user.

20. A non-transitory computer-readable medium storing instructions that, when executed by one or more processors of a processing circuit, cause the processing circuit to:
authenticate a first user of a plurality of users configured to access a data exchange platform;
retrieve, responsive to authenticating the first user, a profile associated with the first user from the data exchange platform, the profile comprising an initial tier assigned to the profile associated with the first user;
receive, via a user interface field rendered on a user device, first data supplied by the first user;
store the first data in a data structure communicatively coupled to the data exchange platform;
determine a score for the first data, the score determined for the first data according to the existing data included in the data structure;
determine an updated tier assigned to the profile associated with the first user, based on the score determined for the first data; and
transmit second data from the data structure to the first user via the user device based on the updated tier assigned to the profile associated with the first user, the second data comprising data received from a subset of users from the plurality of users, the subset of users corresponding to the updated tier assigned to the profile associated with the first user.
